(19) United States
(12) Patent Application Publication
(10) Pub. No.: US 2013/0287256 A1
(43) Pub. Date: Oct. 31, 2013

(54) METHOD AND SYSTEM FOR REAL TIME IMAGE RECOGNITION ON A MOBILE DEVICE

(71) Applicant: TELIBRAHMA CONVERGENT COMMUNICATIONS PRIVATE LIMITED, (US)

(72) Inventors: SURESH NARASIMHA, BANGALORE (IN); RAMYA NANJUNDA ARADHYA, BANGALORE (IN); SANTHOSH SHAMANNA, BANGALORE (IN); MEHUL DIVECHA, BANGALORE (IN)

(73) Assignee: TELIBRAHMA CONVERGENT COMMUNICATIONS PRIVATE LIMITED, Bangalore (IN)

(21) Appl. No.: 13/872,863

(22) Filed: Apr. 29, 2013

(30) Foreign Application Priority Data
Apr. 30, 2012 (IN) 1236/CHE/2012
Apr. 30, 2012 (IN) 1237/CHE/2012

(51) Int. Cl. G06K 9/62

(52) U.S. Cl. CPC G06K 9/6201
USPC 382/103

(57) ABSTRACT

The various embodiments herein provide a method and system for real time image searching on a mobile device. The method comprises of installing an image recognition application in the mobile device, capturing one or more images using the mobile device and recognizing a plurality of images in successive frames by ranking one or more feature points of the captured images through the image recognition application. The ranking of feature points is performed by generating a random forest for the images, obtaining a plurality of features points in the captured images using a feature based method, matching the images captured through the mobile device with the plurality of images stored in the random forest, designating a rank for the tracked feature points in the images, determining the stable features of the images, recognizing the matched image based on stable features and delivering the content based on the recognized object.

### CROSS-REFERENCE TO RELATED APPLICATIONS

The present application, claims priority of the Indian provisional patent applications with serial number 1236/CHE/2012 and 1237/CHE/2012 filed on Apr. 30, 2012, and that applications are incorporated in its entirety at least by reference.

### BACKGROUND

1. Technical Field

The embodiments herein, generally relate to image processing systems and methods and particularly relates to a method and system for recognizing an image and searching the image data in real time. The embodiments herein more particularly relates to a method and system for expediting real time image recognition on a user mobile device by performing feature extraction and enumerating feature ranking.

2. Description of the Related Art

An image generally has one or more enclosed/closed contours, which is a fixed or random area in the image depicting an object, a logo or a HD picture. The enclosed contour is made up of various regions whose characteristics changes with a variation in the scale of the enclosed contour, variation in the rotation of an angle of view of the enclosed contour or depends on affinity variation. The conventional methods use High Definition (HD) cameras to capture an image of an enclosed contour or logo. The captured image is processed through a plurality of applications installed on end user device like a PC, a laptop and a Smartphone. The ED cameras capture the image of a logo with a fixed background to ensure the accuracy of processing of the image.

The existing method classifies an image on the basis of intensity; color and visual orientation to provide recognition and description of successive frames of the captured images. Further classification of the image is done to map ideal features of the plurality of images. However, the mapping of the ideal image features is affected variably when the images in the successive frames render wide differences in respective of intensity, color, visual orientation and the like.

The existing technologies perform image recognition by segmenting the captured image into one or more connected regions. The segmented objects comprise significant information which is then processed by a processor application. However, the processing of the segmented connected regions is significantly affected by the variations in the image parameters such as a scale of the image, a view angle of the image and an affinity of the image. The variation in the plurality of the image parameters leads to improper outcome after processing of images. Since a segmented zone comprises one or more colors, the segmentation of the image on the basis of an area leads to inefficient processing. Similarly, processing of an image/logo with frequently varying background is highly cumbersome. As the background of the logo frequently changes in Television and motion pictures, the captured image of the logo suffers aberrations and frequent color variations. The processing of the logo becomes difficult as the background of the logo on the Television is dynamic in nature. Furthermore the recognition of the logo becomes difficult on the Television due to the raster lines created by Television, uneven lighting conditions and noise. Also the image of the Television logo which is captured by the smartphone is of low quality so the processing of the captured image is inappropriate.

Further the current technologies explain only a generic image recognition methods using mobile device and does not explain a contour or shape based image recognition. Another prior art uses key points based on only image processing, but not image recognition. The prior arts also tail to provide details regarding differentiating various shapes in a particular image.

In the view of foregoing, there is a need for a method and system for recognizing the images and enable image searching in a mobile device. There is also a need for a method and system for extracting contour data of a particular image area in a captured image with high efficiency. Further is a need for a method and system for recognizing the image based on a logo with dynamic background and to provide the relevant contents based on the recognized logo to the mobile device.

The above mentioned shortcomings, disadvantages and problems are addressed herein and which will be understood by reading and studying the following specification.

### SUMMARY

The primary objective of the embodiments herein is to provide a method and system for real time image recognition on a mobile device based on a ranking based procedure.

Another objective of the embodiments herein is to provide a method and system to track a plurality of feature points in the captured image and designate ranks to the tracked/matched feature points.

Another objective of the embodiments herein is to provide a method and system for image recognition based on an enclosed contour in a captured image on a mobile device.

Another objective of the embodiments herein is to provide a method and system for Image recognition of an enclosed contour based on a color pattern.

Another objective of the embodiments herein is to provide a method and system to segment a captured close contour where the edges are not prominent on the basis of color pattern.

Another objective of the embodiments herein is to provide a method and system for-image recognition based on the enclosed contour which is shape variant, angle variant, and affine invariant.

Another objective of the embodiments herein is to provide a method and system to match the features of the plurality of the images in the successive frames offline on the mobile phone.

Another objective of the embodiments herein is to provide a method and system for real time recognition of a logo on a plurality of Television channels with varying background through a mobile device.

Another objective of the embodiments herein is to provide a method and system for retrieval of relevant digital content based on the recognized logo.

These and other objects and advantages of the present embodiments will become readily apparent from the following detailed description taken in conjunction with the accompanying drawings.

The various embodiments of the present invention provide a method for real time image recognition on a mobile device. The method comprises of installing an image recognition application in the mobile device, capturing a plurality of images using the mobile device and recognizing a plurality of images in successive frames by ranking one or more feature points of the captured images through the image recognition application. The method of ranking one or more feature points of the captured images comprises of generating a random forest for the plurality of images, storing the generated random forest in a training module in an application server, passing the random forest to the mobile device, passing the captured images through an image recognition process on the mobile device, obtaining a plurality of features points in the captured images using a feature based algorithm, matching the image captured through the mobile device with the plurality of images stored in the random forest, designating a rank for the tracked feature points in the images, incrementing the designated ranks based on a repetition of the feature points in the images of the successive frames, determining one or more stable features of the images by ranking the features points based on a threshold and repetition, applying Ransac on the identified stable features, recognizing the matched image and delivering the content based on the recognized image.

According to an embodiment herein, the incremented ranks for the tracked feature points are matched with a predetermined threshold value in each frame through at least one of an inliers count and a Ransac percentage count.

According to an embodiment herein, the stable features comprise one or more feature points whose incremented rank equalize or cross the predetermined threshold value.

According to another embodiment herein, the method comprises recognizing an image based on an enclosed contour in a image. The method comprises of capturing the image of the enclosed contour through the mobile device, subjecting the captured image to the image recognition application, analyzing a color pattern of the enclosed contour through the image recognition application, extracting a shape of the enclosed contour from the identified color pattern, segmenting the enclosed contour into a plurality of connected regions based on the identified color pattern and the shape and transforming and normalizing the identified shapes to recognized the image contour.

According to an embodiment herein, the method of extracting the shape of the enclosed contour from the color pattern comprises of binarizing the image of the enclosed contour based on one or more image dependent techniques, performing blob segmentation of the image after binarization, normalizing each segmented blob for scaling and orientation, passing the segmented blob to a Zernike moment generator and storing the Zernike moments as descriptors to define the shape.

According to an embodiment herein, binarizing the image is performed based on at least one of a color; brightness threshold and adaptive threshold.

According to an embodiment herein, the method of normalizing the identified shape comprises of segmenting the binarized enclosed contour to fit into an elliptic region, obtaining the elliptical properties of the shape of the segmented and binarized contour, calculating the central moments, calculating the elliptical values derived, computing a new normalized contour, subjecting the new normalized contour to a descriptor computation process by convolving the normalized contour with one or more Zernike polynomials.

According to an embodiment herein, convolution of the normalized contour with the one or more Zernike polynomials provides a 36 dimensional contour descriptor. Here both magnitude component and a phase component are included to represent the contour shape in the form of descriptor.

According to another embodiment, herein, the method of extracting the shape of the enclosed contour is based on a scale space.

According to another embodiment, herein, the real time image recognition further comprising providing information on at least one logo included in at least one digital content in the mobile device. The method of providing information on logo, for instance, television logo comprises capturing the image of the logo from the digital content through the mobile device, extracting one or more features from the image of the logo, passing the extracted features through a K-dimensional tree, matching the extracted features with a plurality of pre-stored logos stored in a Random Forrest, recognizing the matched image based on stability of features on one or more preceding frames and delivering a content based on the recognized image of the logo to the mobile device. The logo is at least one of a symbol, text or a graphical image which represents an identity of a producer, content distributor or broadcasting network of the digital content. The method of recognizing logo further comprising initializing an image recognition application installed in the mobile device, recognizing the image of the logo by the image recognizing application, obtaining a key ID corresponding to the logo and getting the contents of the recognized image from an application server to the image recognition application based on the key ID.

According to an embodiment herein, the contents of the recognized logo is downloaded from the application server or streamed through the application server.

According to an embodiment herein, the digital content is a program content with varying background broadcasted on a television channel.

According to an embodiment herein, the method of generating the random forest for the plurality of images comprises calculating the feature points of the pre-stored training images, describing and labeling a data set for the one or more images, clustering the labeled data set using a K-means clustering, creating a K-dimensional tree for the clustered data based on the calculated feature points, generating an XML code and parsing the clustered data from the application server to the mobile device in the form of extensible markup language (XML).

According to an embodiment herein, the random forest is an ensemble classifier comprising a plurality of decision trees and adapted to provide a class, where the class is a mode of the classes output by one or more individual trees.

According to an embodiment herein, extracting one or more features from the image comprises calculating one or more feature points for the Image using a feature based algorithm.

Embodiments herein provide a system for real, time Image recognition on a mobile device. The system comprising a mobile device equipped with a camera, an image recognition application Installed in the mobile device, an application server, a processor means and a training module provided in the application server. The image recognition application in the mobile device is adapted for recognizing the plurality of images in successive frames and matching the captured image with one or more pre-stored images. The processor means is adapted for obtaining a plurality of features points in the captured images using a feature based algorithm, matching the plurality of feature points with the plurality of images stored in the random forest, designating a rank for the tracked feature points in the images, incrementing the designated ranks based on the repetition of the feature points in the images of successive frames and determining one or more stable features of the images, matching the stable features with the features belonging to the plurality of images stored in the random forest and recognizing the images based on the stable features.

The training module provided in the application server is adapted for storing a plurality of pre-loaded images and generating a random forest for the plurality of images.

According to an embodiment herein, tire processor means is further adapted for initiating the image recognition application to identify the image of an enclosed contour, analyzing a color pattern, a brightness threshold and an adaptive threshold of the enclosed contour, extracting a shape of the enclosed contour, segmenting the enclosed contour into a plurality of connected regions based on the shape and transforming and normalizing the identified shapes.

According to an embodiment herein, the image recognition application is a software application installed in the mobile device through which the captured image is analyzed and processed.

Embodiments herein further provide a system for identifying a logo on a Television with a varying background. The system comprises a mobile device equipped with a camera with which the user captures images of one or more television logos/normal logos, an image recognition application installed in the mobile device adapted for recognizing the image of the logo, obtaining a key ID corresponding to the recognized logo and extracting contents for the recognized logo. The system further comprises an application server and a training module provided in the application server adapted for storing a plurality of training images of logos and constructing a random forrest for facilitating the logo search.

These and other aspects of the embodiments herein will be better appreciated and understood when considered in conjunction with the following description and the accompanying drawings. It should be understood, however, that the following descriptions, while indicating preferred embodiments and numerous specific details thereof are given by way of illustration and not of limitation. Many changes and modifications may be made within the scope of the embodiments herein without departing from the spirit thereof, and the embodiments herein include ail such modifications.

### BRIEF DESCRIPTION OF THE DRAWINGS

The other objects, features and advantages will occur to those skilled in the art from the following description of the preferred embodiment and the accompanying drawings in which;

FIG. 1 is a block diagram illustrating a system for providing image recognition on a mobile device, according to an embodiment of the present disclosure.

FIG. 2 is a flow diagram illustrating a method of recognizing an image on a mobile device in real time, according to an embodiment of the present disclosure.

FIG. 3 is a flow diagram illustrating a process of ranking feature points of the captured images, according to an embodiment of the present disclosure.

FIG. 4 is a flow diagram illustrating a process for generating a random forest tree from the plurality of pre-stored images, according to an embodiment of the present disclosure.

FIG. 5 is a flow diagram illustrating a process of recognizing an image based on an enclosed contour in a captured image, according to another embodiment of the present disclosure.

FIG. 6 is a flow diagram illustrating a process of extracting the shape of the enclosed contour from an image, according to an embodiment of the present disclosure.

FIG. 7 is a flow diagram illustrating a process of normalizing the identified shape in a captured image, according to an embodiment of the present disclosure.

FIG. 8 is a flow diagram illustrating a method for recognizing a logo on a Television channel and delivering content based on the logo to a user mobile device, according to an example embodiment of the present disclosure.

Although the specific features of the present embodiments are shown in some drawings and not in others. This is done for convenience only as each feature may be combined with any or all of the other features in accordance with the present embodiments.

### DETAILED DESCRIPTION OF THE DRAWINGS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments of the present invention provide a method for real time image recognition on a mobile device. The method comprises of installing an image recognition application in the mobile device, capturing a plurality of images using the mobile device and recognizing a plurality of images in successive frames by ranking one or more feature points of the captured images through the image recognition application. The method of ranking one or more feature points of the captured images comprises of generating a random forest for the plurality of images, storing the generated random forest in a training module in an application server, passing the random forest to the mobile device, passing the captured images through an image recognition process on the mobile device, obtaining a plurality of features points in the captured images using a feature based algorithm, matching the image captured through the mobile device with the plurality of images stored in the random forest, designating a rank for the tracked feature points in the images, incrementing the designated ranks based on a repetition of the feature points in the images of the successive frames, determining one or more stable features of the images by ranking the features points based on a threshold and repetition, applying Ransac on the identified stable features, recognizing the matched image and delivering the content based on the recognized image.

The incremented ranks for the tracked feature points are matched with a pre-determined threshold value in each frame through at least one of an inliers count and a Ransac percentage count. Here the stable features comprise one or more feature points whose incremented rank equalize or cross the predetermined threshold value.

The method of recognizing an image based on an enclosed contour in an image comprises of capturing the image of the enclosed contour through the mobile device, subjecting the captured image to the image processor application, analyzing a color pattern of the enclosed contour through the image recognition application, extracting a shape of the enclosed contour from the identified color pattern, segmenting the enclosed contour into a plurality of connected regions based on the identified color pattern and the shape and transforming and normalizing the identified shapes. Extracting the shape of the enclosed contour from the color pattern comprises of binarizing the image of the enclosed contour based on one or more image dependent techniques, performing blob segmentation of the image after binarization, normalizing each segmented blob for scaling and orientation, passing the segmented blob to a Zernike moment generator and storing the Zernike moments as descriptors to define the shape.

The binarization of the image is performed based on at least one of a color, brightness threshold and adaptive threshold.

Normalizing the identified shape of the enclosed contour comprises of segmenting the binarized enclosed contour to lit into an elliptic region, obtaining the elliptical properties of the shape of the segmented and binarized contour, calculating the central moments, calculating the elliptical values derived, computing a new normalized contour, subjecting the new normalized contour to a descriptor computation process by convolving the normalized contour with one or more Zernike polynomials. The convolution of the normalized contour with the one or more Zernike polynomials provides a 36 dimensional contour descriptor. Here both magnitude component and a phase component are included to represent the contour shape in the form of descriptor.

In one embodiment herein, the method of extraction of the shape of the enclosed contour is based on a scale space.

The real time image recognition further comprises of providing information on at least one logo included in at least one digital content in the mobile device. The method of providing Information on logo, for instance, television logo comprises capturing the image of the logo from the digital content through the mobile device, extracting one or more features from the image of the logo, passing the extracted features through a K-dimensional tree, matching the extracted features with a plurality of pre-stored logos stored in a Random Forrest, recognizing the matched image based on stability of features on one or more preceding frames and delivering a content based on the recognized image of the logo to the mobile device. The logo is at least one of a symbol, text or a graphical image which represents an identity of a producer, content distributor or broadcasting network of the digital content. The method of recognizing logo further comprising initializing an image recognition application installed in the mobile device, recognizing the image of the logo by the image recognizing application, obtaining a key ID corresponding to the logo and getting the contents of the recognized image from an application server to the image recognition application based on the key ID.

The contents of the recognized logo is downloaded from the application server or streamed through the application server. The digital content is a program content: with varying background broadcasted on a television channel.

The method of generating the random forest, for the plurality of images comprises calculating the feature points of the pre-stored training images, describing and labeling a data set for the one or more images, clustering the labeled data set using a K-means clustering, creating a K-dimensional tree for the clustered data based on the calculated feature points, generating an XML code and parsing the clustered data from the application server to the mobile device in the form of extensible markup language (XML). The random forest is an ensemble classifier comprising a plurality of decision trees and adapted to provide a class, where the class is a mode of the classes output by one or more individual trees.

Embodiments herein provide a system for real time image recognition on a mobile device. The system comprising a mobile device equipped with a camera a plurality of images, an image recognition application installed in the mobile device, an application server, a processor means and a training module provided in the application server. The image recognition application in the mobile device is adapted for recognizing the plurality of images in successive frames and matching the captured image with one or more pre-stored images. The processor means is adapted for obtaining a plurality of features points in the captured images using a feature based algorithm, matching the plurality of feature points with the plurality of images stored in the random forest, designating a rank for the tracked feature points in the images, incrementing the designated ranks based on the repetition of the feature points in the images of successive frames determining one or more stable features of the images, matching the stable features with the features belonging to the plurality of images stored in the random forest and recognizing the images based on the stable features.

The training module provided in the application server is adapted for storing a plurality of pre-loaded images and generating a random forest for the plurality of images.

The processor means is further adapted for initiating the image recognition application to identify the image of an enclosed contour, analyzing a color pattern, a brightness threshold and an adaptive threshold of the enclosed contour, extracting a shape of the enclosed contour, segmenting the enclosed contour into a plurality of connected regions based on the shape and transforming and normalizing the identified shapes.

The image recognition application is a software application installed in the mobile device through which the captured image is analyzed and processed.

Embodiments herein further provide a system for identifying a logo on a Television with a varying background. The system comprises a mobile device equipped with a camera with which the user captures images of one or more television logos, an image recognition application installed in the mobile device adapted for recognizing the image of the logo, obtaining a key ID corresponding to the recognized logo and extracting contents for the recognized logo. The system further comprises an application server and a training module provided in the application server adapted for storing a plurality of training images of logos and constructing a random forrest for facilitating the logo search.

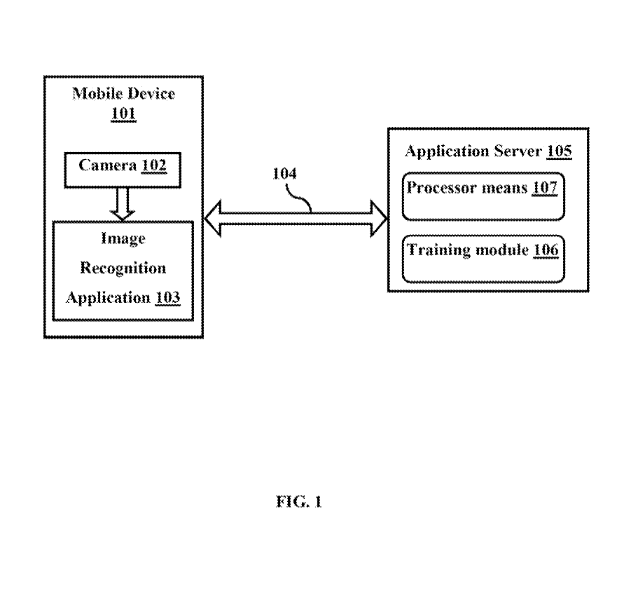

FIG. 1 is a block diagram illustrating a system for providing image recognition on a mobile device, according to an embodiment of the present disclosure. The system comprises a mobile device 101, a communication medium 104 and an application server 105. The mobile device 101 is equipped with a camera 102 to capture a plurality of images and an image recognition application 103. The image recognition application 103 is pre-installed in the mobile device or is downloaded and installed from an application database on the mobile device. The communication medium 104 is any one of a wired or a wireless medium such as Wi-Fi, Bluetooth, WLAN, Cellular networks, etc. The camera setup on the mobile device is any one of a video graphic array (VGA) camera or a high definition camera with enhanced imaging quality. The application server 105 comprises a training module 106 and a processor means 107. The processor means 107 is adapted for obtaining a plurality of features points in the captured images using a feature based algorithm, matching the plurality of feature points with the plurality of images stored in the random forest, designating a rank for the tracked feature points in the images, incrementing the designated ranks based on the repetition of the feature points in the images of successive frames, determining one or more stable features of the images, matching the stable features with the features belonging to the plurality of images stored in the random forest and recognizing the images based on the stable features. The training module 106 is adapted for storing a plurality of pre-loaded images and generating a random forest for the plurality of images.

The image recognition application 103 installed in the mobile device provides recognition of a plurality of images in the successive frames. The image recognition application 103 matches the captured image with the image provided by the training module 106 in the application server 105. Alternatively, instead, of recognizing the captured image in the mobile device, the image recognition application 103 uploads the captured images to the application server 105 and the matching process of the uploaded image is performed in the application server 105.

According to an embodiment herein, the processing and identification of an image is done in real time in high end mobile devices 101 such as smart phones. For the low end mobile devices 101, the captured images are sent to the application server for processing. The training module 106 provided in the application server stores a plurality of pre-loaded images and constructs a random forest tree for the plurality of images. The images are further recognized based on the stable features.

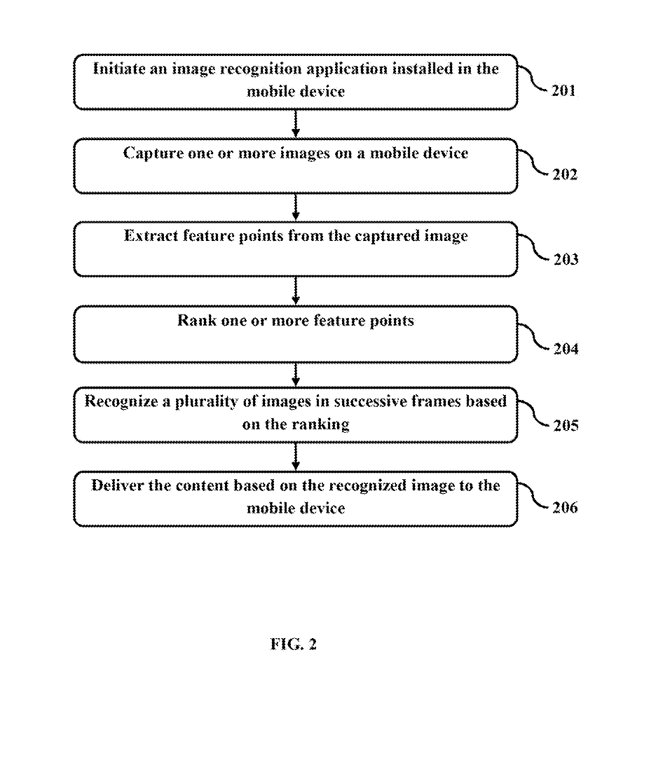

FIG. 2 is a flow diagram illustrating a method of recognizing an image in a mobile device in real time, according to an embodiment of the present disclosure. The mobile device herein is equipped with an image capturing means such as a camera. The user captures one or more images from the surroundings such as an object or any scene (202). The captured images are stored in the local memory of the mobile device. The user initiates the image recognition application installed in the mobile device to recognize one or more images to perform an effective image searching (202). Alternatively, the captured image is uploaded to an application server through the image recognition application for further processing. The application server comprises a training module having a plurality of pre-loaded training images. The training module further constructs a random forest tree for the plurality of images. The image recognition application then extracts the feature points from the captured images by matching the extracted features against the features of the training images stored in the random forest using a feature extraction algorithm (203). The feature points are extracted for successive images. Based on repetition or occurrence of a particular feature, the mostly occurred feature points are designated with a rank (204). Now, based on the ranking, the plurality of images in the successive frames is recognized (205). On recognition of the image, the information related to the recognized image is delivered to the user device through a connected communication medium (206).

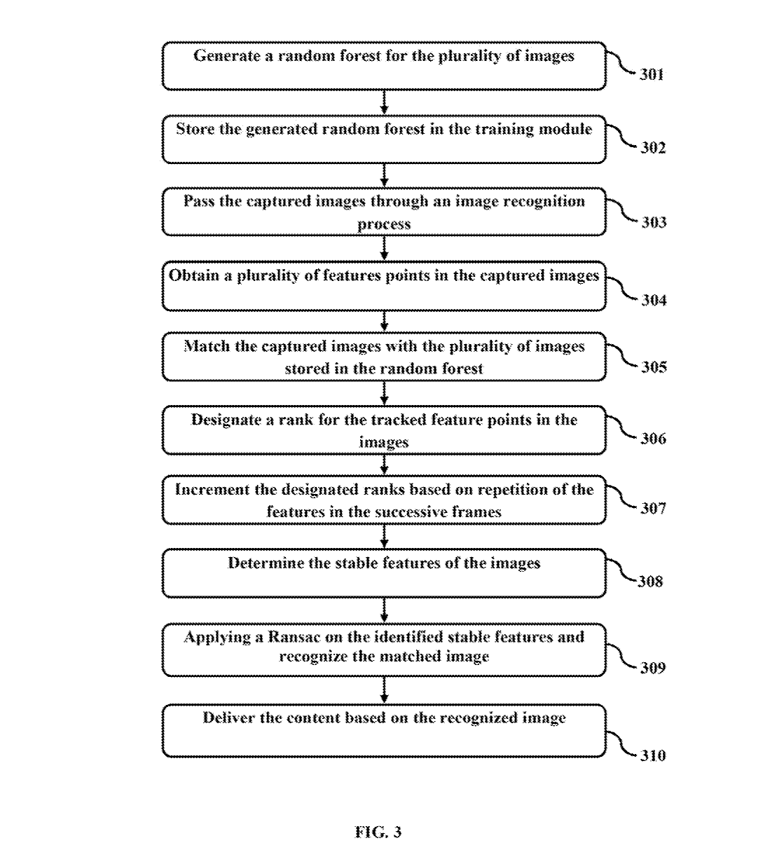

FIG. 3 is a flow diagram illustrating a process of ranking feature points of the captured images, according to an embodiment of the present disclosure. The method for real time image search based on ranking comprises generating a random forest for a plurality of images (301). The generated random forest tree is then stored in the training module (302). The plurality of images captured by the user in the successive frames is then passed through an image recognition process (303). The image recognition process comprises tracking and obtaining a plurality of features points in the captured images. The feature points are foe information which describes the image in detailed manner (304). The feature points of the captured images are calculated or extracted by applying a feature based algorithm. The feature points of the captured image are matched with the features of foe plurality of images stored in the random forest (305). A rank is designated for the tracked feature points in the images (306). The designated ranks are incremented on the basis of repetition of the feature point in the images of successive frames (307). The incremented ranks for the tracked feature points are matched with a pre-determined threshold value in each frame. Then one or more stable features of the images are determined on the basis of the incremented ranks. The feature points whose incremented rank equalize or cross the predetermined threshold value are determined as the stable features (308). Ransac is then applied on the identified stable features and recognizes the matched image (309). Further the content based on the recognized image is delivered to the user device (310).

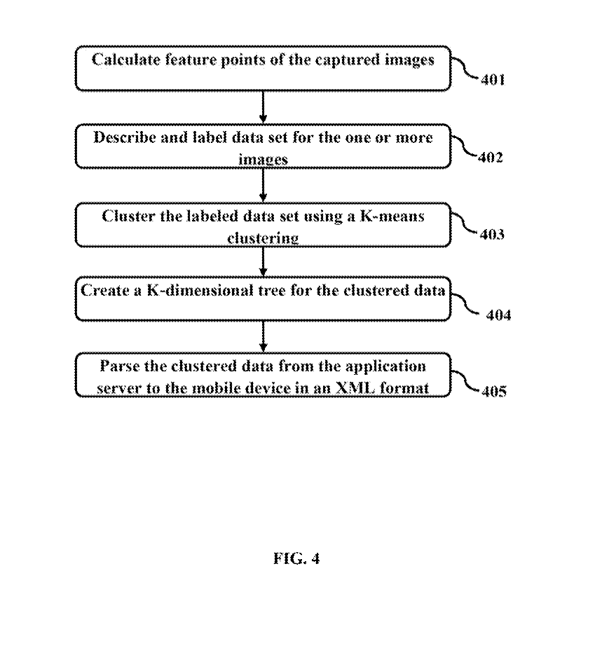

FIG. 4 is a flow diagram illustrating a process for generating a random forest tree from the plurality of prestored training images, according to an embodiment of the present disclosure. The method comprises calculating one or more feature points of the captured image using a feature based algorithm (401). The feature based method is applied for a plurality of training images and then plurality of data for the training images is extracted. The extracted data is implemented to create a plurality of tree. The tree is a graph consisting of two or more nodes in the data structure. The method further comprises describing and labeling a data set for the pluralities of the images (402). Then, the labeled data set or trees are clustered using a K-means (403). The K-means method provides a k-dimensional data structure or tree which is further clustered to form the random forest. The feature based algorithm is again executed for calculating the features of the clustered data set. The pluralities of clustered trees are used for creating the extensive marking language (XML) file. A K-dimensional tree is created for the clustered data on the basis of the calculated features (404). Then, the clustered data is parsed from the application server to the user device in the form of extensible making language (XML) (405). The parsed XML file is used for creating a multidimensional random forest. The created random forest is stored in the application server or in the mobile device. The random forest is an ensemble classifier that consists of many decision trees. The random forest provides outputs in the form of a class that is the mode of a plurality of class's outputs.

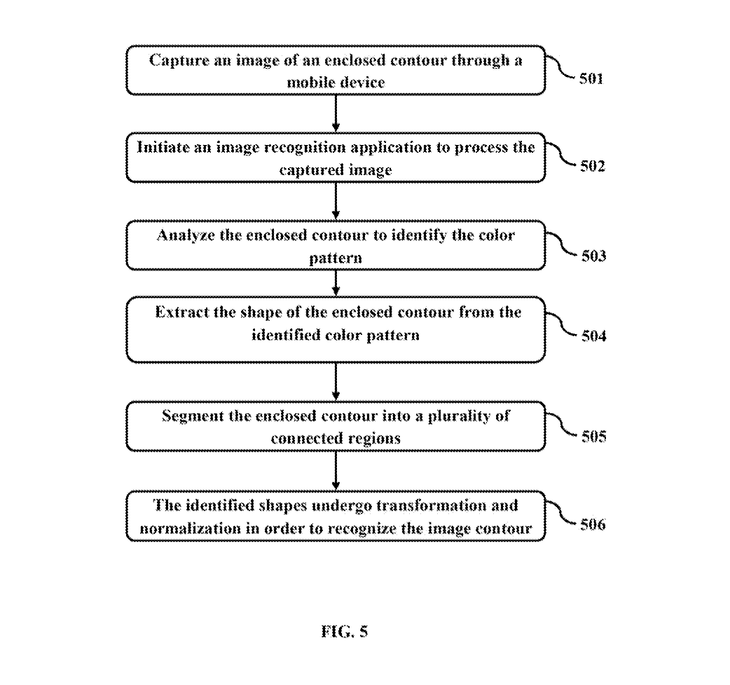

FIG. 5 is a flow diagram illustrating a process of recognizing an image based on one or more enclosed contours in the captured image, according to another embodiment of the present disclosure. A user captures an image having one or more enclosed contours using a mobile device equipped with a camera (501). The image of a desired object is captured from a plurality of surfaces such as from newspapers, magazines, vehicles etc. with various background colors, lighting/illumination conditions. The image recognition application is then initiated to process the captured image (502). Alternately, the image recognition application transfers the captured image to a central server for optimal image processing. The central server processes the image in the scenarios when the captured image is complex or the user mobile device has low hardware configurations, etc. The image recognition application analyzes a color pattern of the enclosed contour in the captured image (503). Based on the identified color pattern, the image recognition application further analyzes and extracts a shape of the enclosed contour (504). Further the enclosed contour is segmented into a plurality of connected regions (505). The identified shapes undergo transformation and normalization in order to satisfy each of the connected regions to be scale/translational invariant, rotation invariant and affine invariant to recognize the image contour (506). The scale invariant signifies that the image contour is recognized whether the image is captured from a distance closer to the object or a distance far away from the object. The rotation invariant signifies that the image captured from different rotational angles is recognizable. The affine invariant signifies that the recognizing the image captured in different views such as perspective, isometric, etc. is not affected during extracting features. Each blob undergoes normalization for orientation and scaling. The image is made translational, rotational and affine invariant in the normalization process.

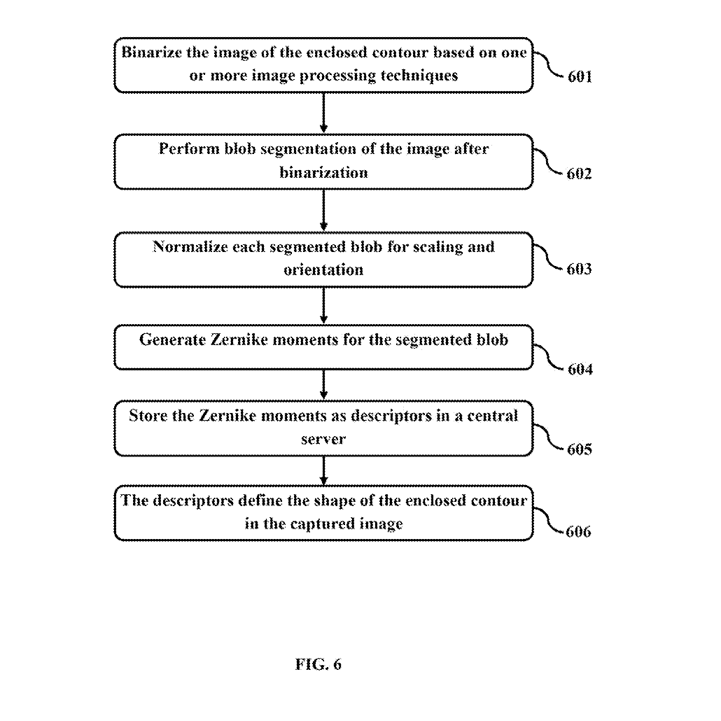

FIG. 6 is a flow diagram illustrating a process of extracting the shape of the enclosed contour from an image, according to an embodiment of the present disclosure. The image recognition application pre-installed in the user mobile device performs binarization of the captured, image (60S). The image of the enclosed contour is binarized based on one or more image processing techniques. The one or more image processing techniques comprise but not limited to a color based binarization, a threshold based binarization and an adaptive threshold based binarization. The one or more image dependent techniques executes in parallel. A specific or combination of the plurality of image dependent techniques are used which provides best result in binarization process. The binarization process is followed by a blob segmentation process (602). The enclosed contour is segmented into a plurality of connected regions called as blobs. Each segmented blobs are normalized for scaling and orientation (603). The normalized blobs are passed to a Zernike moment generator for generating Zernike moments for the segmented blob (604). The Zernike moment is obtained from a Zernike polynomial. Based on the predetermined order of the Zernike polynomial, pluralities of different orthogonal shaped moments are formed. The embodiment herein preferably adopts an order of ten but is capable of adopting a higher order Zernike polynomial for accurate image recognition. For every order of the Zernike polynomial, a magnitude and a phase value are calculated. The set of magnitude and phase values are used for recognizing a query image. The Zernike moments are stored as descriptors in a central server. The Zernike moment defines the shape of the object in the captured image (605).

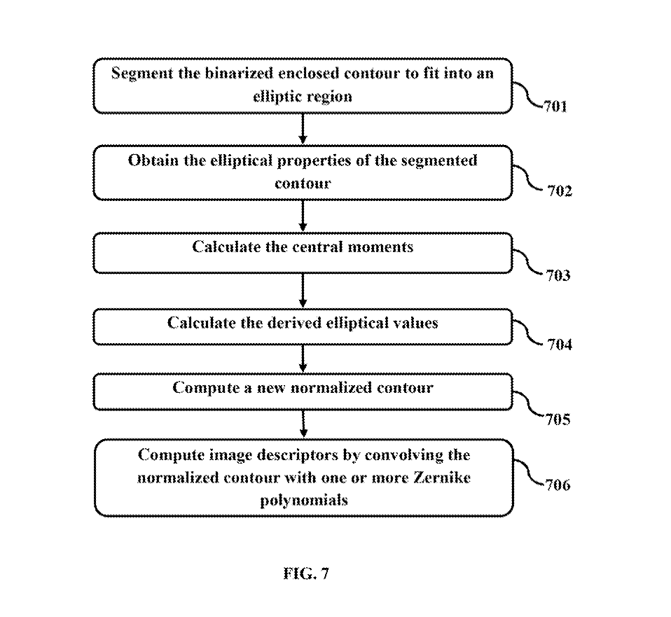

FIG. 7 is a flow diagram illustrating a process of normalizing the identified shape in a captured image, according to an embodiment of the present disclosure. The captured image or the enclosed contour in the image is processed through the image recognition application. The image recognition application adopts a plurality of image processing techniques for binarization of the captured image. The binarized enclosed contour is segmented to fit into an Elliptic region (70S). An ellipse is an affine invariant shape. The elliptical properties of a shape of the segmented contour are obtained by a second order central moments (702). The central moments are then calculated (703). Further calculate the derived elliptical values (704) and compute a new normalized contour (705). The normalized contour is further subjected to a descriptor computation process to compute the image descriptors by convolving the normalized contours with the complex Zernike polynomials (706). The convolution of the normalized contour with the complex Zernike polynomials provides a 36 dimensional contour descriptor. Both magnitude and phased components are included to represent the shape in the form of descriptor. The 36 dimensional contour descriptors are matched with image descriptors pre-stored in a training data module. The training data module stores the image descriptors in a k-dimensional tree (k-d tree). The pre-stored image descriptors are matched with the 36 dimensional image descriptors, using a Euclidian distance method. The result of the matched contour is delivered to the user's mobile device.

According to an embodiment herein, the central moments are computed by given equations:

$$\text{?} \\ \text{?} \\ \text{?} \text{indicates text missing or illegible when filed} \qquad ( 303 )$$

The Elliptical values derived from above mentioned equations are further computed using the following equations:

$$Majoraxislength = 2 \sqrt{2} \sqrt{{u}_{xx} + {u}_{yy} + \sqrt{{( {u}_{xx} - {u}_{yy} )}^{2} + 4 {u}_{xy}^{2}}} \\ \text{?} \\ \text{?} \\ \text{?} \text{indicates text missing or illegible when filed} \qquad ( 304 )$$

From a major axis length (2a), a minor axis length (2b) and an angle (θ) are used to compute a new normalized image (x′, y′):

$$\text{?} \\ \text{?} \text{indicates text missing or illegible when filed} \qquad ( 305 )$$

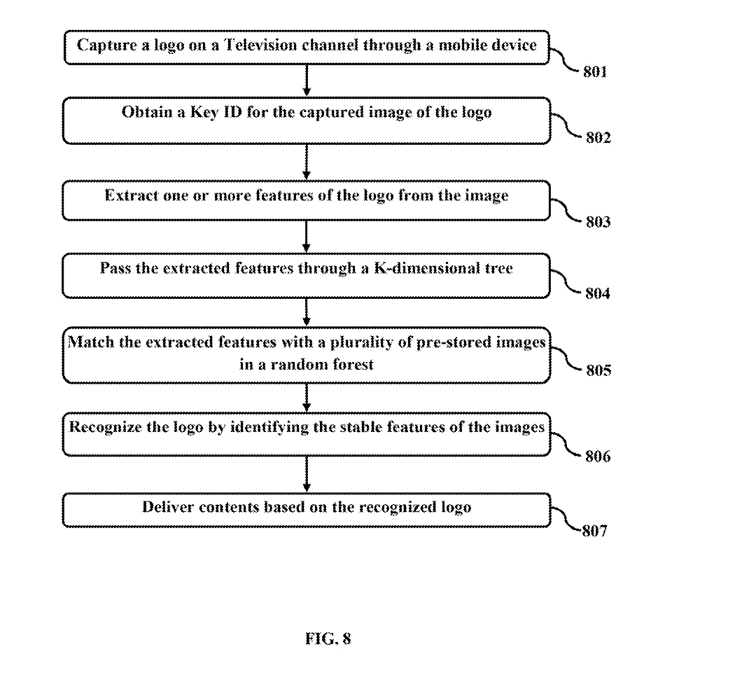

FIG. 8 is a flow diagram illustrating a method for recognizing a logo on a Television channel and delivering content based on the logo to a user mobile device, according to an example embodiment of the present disclosure. The image recognition application installed in the mobile device is initiated and the user captures one or more real time images of a channel logo from the Television channel with varying background (801). The captured images of the logos are stored in the local memory of the mobile device. The captured logo is then processed through the image recognition application. The image recognition application obtains a key ID corresponding to the individual Television channel logo and uploads or transmits the captured logo content to an application server (802). The application server comprises a training module which extracts one or more feature points from the captured image of the logo by adopting a feature based algorithm (803). The training module generates and stores a Random Forrest, which comprises a plurality of pre-loaded training images. The feature points are extracted for successive image frames and processed. The one or more feature points are then passed through a K-dimensional tree (804). An individual tree in the Random Forrest is known as K-dimensional tree. The feature points of the captured image are then matched with the plurality of images stored in the Random Forrest (805). Further one or more stable features are determined for the captured image of the logo and the stable features are matched with the plurality of images stored in the Random Forrest tree (806). The captured image is recognized and content based on the recognized image is delivered to the user mobile device through a connected communication medium (807).

According to an embodiment herein, for high end smart phones the processing and identification of a logo is done on real time within the smart phone itself. For the tow end mobile devices the image processing is done at the application server. The method for recognizing an image of a Television logo within the mobile device comprises installing and initiating an image recognition application. The user captures the image of a Television logo in real time. The captured logo is then processed through the image recognition application. The image recognition application calculates the features of the image though the feature based algorithm. The features are transferred to the K-dimensional tree for searching. The K-dimensional tree is stored in the training module of the application server. The image recognition application uses BestBin Search method for searching the features in the K-dimensional tree. The outlines and mismatched features are removed by the image recognition application by using a Ransac method. The image matching is done on the basis of the non-linear and Ransac percentage count. The content of the image of the logo is sent to the application server on the basis of a key ID. The key ID is generated corresponding to the individual Television logo. The contents for the recognized logo is downloaded or streamed through the application server. The contents for the recognized logo is any one of a single tone audio, a multiple tone audio, a two-dimensional image (2D), a 2D video, a three-dimensional image (3D), a 3D video and a text.

The foregoing description of the specific embodiments will so fully reveal the general nature of the embodiments herein that others can, by applying current knowledge, readily modify and/or adapt for various applications such specific embodiments without departing from the generic concept, and therefore, such adaptations and modifications should and are intended to be comprehended within the meaning and range of equivalents of the disclosed embodiments, it is to be understood that the phraseology or terminology employed herein is for the purpose of description and not of limitation. Therefore, while the embodiments herein have been described in terms of preferred embodiments, those skilled in the art will recognize that the embodiments herein can be practiced with modification.

What is claimed is:

1. A method for real time image recognition on a mobile device, the method comprises of:
installing an image recognition application in the mobile device;
capturing a plurality of images using the mobile device; and
recognizing a plurality of images in successive frames by ranking one or more feature points of the captured images through the image recognition application, wherein ranking one or more feature points of the captured images comprises of;
generating a random forest for the plurality of images;
storing the generated random forest in a training module in an application server;
passing the random forest to the mobile device;
passing the captured images through an image recognition process on the mobile device;
obtaining a plurality of features points in the captured images using a feature based algorithm;
matching the image captured through the mobile device with the plurality of intakes stored in the random forest;
designating a rank for the tracked feature points in the images;
incrementing the designated ranks based on a repetition of the feature points in the images of the successive frames;
determining one or more stable features of the images by ranking the features points based on a threshold and repetition;
applying a Ransac on the identified stable features;
recognizing the matched image; and
delivering the content based on the recognized image.

2. The method of claim 1, wherein the incremented ranks for the tracked feature points are matched with a pre-determined threshold value in each frame through at least one of an inliers count and a Ransac percentage count.

3. The method of claim 1, wherein the stable features comprises one or more feature points whose incremented rank equalize or cross the predetermined threshold value.

4. The method of claim 1, further comprising recognizing an image based on an enclosed contour in the image, wherein the method comprises of:
capturing the image of the enclosed contour through the mobile device, subjecting the captured image to the image processor application, analyzing a color pattern of the enclosed contour through the image recognition application;
extracting a shape of the enclosed contour from the identified color pattern;
segmenting the enclosed contour into a plurality of connected regions based on the identified color pattern and the shape; and
transforming and normalizing the identified shapes.

5. The method of claim 4, wherein extracting the shape of the enclosed contour from the color pattern comprises of:
binarizing the image of the enclosed contour based on one or more image dependent techniques;
performing blob segmentation of the image after binarization;
normalizing each segmented blob for scaling and orientation;
passing the segmented blob to a Zernike moment generator; and
storing the Zernike moments as descriptors to define the shape.

6. The method of claim 5, wherein binarizing the image is performed based on at least one of a color, brightness threshold and adaptive threshold.

7. The method of claim 4, wherein normalizing the identified shape comprises of;
segmenting the binarized enclosed contour to fit into an elliptic region;
obtaining the elliptical properties of the shape of the segmented and binarized contour;
calculating the central moments;
calculating the elliptical values derived;
computing a new normalized contour; and
subjecting the new normalized contour to a descriptor computation process by convolving the normalized contour with one or more Zernike polynomials.

8. The method of claim 7, wherein convolution of the normalized contour with the one or more Zernike polynomials provides a 36 dimensional contour descriptor, wherein a magnitude component and a phase component is included to represent the contour shape in the form of descriptor.

9. The method of claim 4, further comprising extracting the shape of the enclosed contour based on a scale space.

10. The method of claim 1, the real time image recognition further comprising providing information on at least one load included in at least one digital content in the mobile device, wherein the method comprises of:
capturing the image of the logo from the digital content through the mobile device;
where the logo is at least one of a symbol, text or a graphical image which represents an identity of a producer, content distributor or broadcasting network of the digital content;
extracting one or more features from the image of the logo;
passing the extracted features through a K-dimensional tree;
matching the extracted features with a plurality of pre-stored logos stored in a Random Forest;
recognizing the matched image based on stability of features on one or more preceding frames; and
delivering a content based on the recognized image of the logo to the mobile device.

11. The method of claim 10, further comprising:
initializing an image recognition application installed in the mobile device;
recognizing the image of the logo by the image recognizing application;
obtaining a key ID corresponding to the logo; and
getting the contents of the recognized image from an application server to the image recognition application based on the key ID.

12. The method of claim 10, wherein the contents of the recognized logo is downloaded from the application server or streamed through the application server.

13. The method of claim 10, wherein the digital content is a program content with varying background broadcasted on a television channel.

14. The method of claim 1, wherein generating the random forest for the plurality of images comprises:
calculating the feature points of the training images;
describing and labeling a data set for the one or more images;
clustering the labeled data set using a K-means clustering;
creating a K-dimensional tree for the clustered data based on the calculated feature points; generating an XML code; and
parsing the clustered data from the application server to the mobile device in the form of extensible markup language (XML).

15. The method of claim 1, wherein the random forest is an ensemble classifier comprising a plurality of decision trees and adapted to provide a class, where the class is a mode of the classes output by one or more individual trees.

16. The method of claim 1, wherein extracting one or more features from the image comprises calculating one or more feature points for the image using a feature based algorithm.

17. A system for real time image recognition on a mobile device, the system comprising;
a camera provided in the mobile device for capturing a plurality of images;
an image recognition application installed in the mobile device adapted for;
recognizing the plurality of images in successive frames;
matching the captured image with one or more pre-stored images;
an application server;
a training module provided in the application server for:
storing a plurality of pre-loaded images; and
generating a random forest for the plurality of images,
a processor means provided in the application server for; and
obtaining a plurality of features points in the captured images using a feature based algorithm;
matching the plurality of feature points with the plurality of images stored in the random forest;
designating a rank for the tracked feature points in the images;
incrementing the designated ranks based on the repetition of the feature points in the images of successive frames;
determining one or more stable features of the images;
matching the stable features with the features belonging to the plurality of images stored in the random forest; and
recognizing the images based on the stable features;

18. The system of claim 17, wherein the processor means is further adapted for:
initiating the image recognition application to identify the image of an enclosed contour;
analyzing a color pattern, a brightness threshold and an adaptive threshold of the enclosed contour;
extracting a shape of the enclosed contour;
segmenting the enclosed contour into a plurality of connected regions based on the shape; and
transforming and normalizing the identified shapes.

19. The system of claim 17 wherein the image recognition application is a software application installed in the mobile device through which the captured image is analyzed and processed.

20. A system for identifying a logo on a Television with a varying background, the system comprising:
a mobile device equipped with a camera with which the user captures images of one or more television logos;
an image recognition application installed in the mobile device adapted for;
recognizing the image of the logo;
obtaining a key ID corresponding to the recognized logo; and
extracting contents for the recognized logo;
an application server; and
a training module provided in the application server adapted for:
storing a plurality of training images of logos; and
constructing a random forrest for facilitating the logo search.
